(19) United States
(12) Patent Application Publication
(10) Pub. No.: US 2008/0192693 A1
(43) Pub. Date: Aug. 14, 2008

(54) Method and Device for Determination of an Address Within an Aeronautical Telecommunication Network

(75) Inventors: Matthieu Borel, Toulouse (FR); Nicolas Rossi, Toulouse (FR); Michel Subelet, Cugnaux (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly-Sur-Seine (FR)

(21) Appl. No.: 11/912,101

(22) PCT Filed: Apr. 6, 2006
(86) PCT No.: PCT/EP2006/061375

§ 371 Date: Oct. 19, 2007

(30) Foreign Application Priority Data
Apr. 16, 2005 (FR) 05 03897

(51) Int. Cl. H04Q 7/20

(52) U.S. Cl. 370/331

(57) ABSTRACT

The present invention relates to the determination of the ground address that an aircraft must call within the aeronautical telecommunication network ATN to prepare a context for digital data exchanges with a ground air traffic control center. It consists in using the GSIF general data broadcast by certain ground telecommunication stations, including VDL ground stations, to enable the router on board an aircraft passing through the coverage area of a routing center to undertake an automatic handshake procedure. This operation consists in identifying the ground telecommunication station concerned by its GSIF data, locating it from this identification and selecting the address of the ground CM application of the air traffic control center closest to the identified ground telecommunication station from a file of ground CM application addresses organized by geographical areas.

### FIELD OF THE INVENTION

The present invention relates to the determination of the ground address that an aircraft must call within the civilian aeronautical telecommunication network, known by the acronym ATN, to prepare a context for digital data exchanges with a ground air traffic control center.

### BACKGROUND OF THE INVENTION

The ATN network is a digital data transmission network dedicated to exchanges of information between the aircraft and the ground for activities including both air traffic control ATC, with the authorities handling control and regulation of the air traffic, and fleet management AOC (Aeronautical Operational Communication) with the airlines operating the aircraft. The information exchanges are divided between various applications, globally designated by the term “Datalink”, which are dedicated according to the people involved such as the CPDLC (Controller Pilot Datalink) application, the ADS (“Automatic Dependent Surveillance”) application or the FIS (“Flight Information Service”) application.

The ATN network comprises an airborne part consisting of air-ground telecommunication means on board aircraft and a terrestrial part consisting of ground telecommunication stations or routing centers equipped with ground-air transmission means enabling them to enter into communication with the aircraft passing through their areas of influence and routing means enabling them to route the communications exchanged with the aircraft to air control centers, airline management centers or even to telecommunication nodes. The transmission means that it uses for the ground-air and air-ground links between an aircraft and a routing center on the ground constitute subnetworks and can involve various digital communication modes, including:
an indirect air-ground and ground-air digital communication mode by telecommunication satellites operating in the UHF band according to a specific “Satcom Data 3” protocol,
an air-ground and ground-air digital communication mode in direct line of sight, by VHF band according to a specific “VDL mode 2 or above” protocol,
an air-ground and ground-air digital communication mode in direct line of sight with a secondary radar according to a specific “S Mode” protocol,
an air-ground and ground-air digital telecommunication mode in HF band according to a specific “HF DL mode” protocol (standing for “High Frequency Datalink”),

Moreover, some ground telecommunication stations, notably VDL stations, periodically broadcast, using specific protocols, general coverage information called GSIF (“Ground Station Information Frame”) containing their identification and, more generally, a set of data necessary for an aircraft to enter into contact.

The various protocols have been defined and standardized by the aeronautical authorities represented by the ICAO (“International Civil Aviation Organization”), at conferences organized by the AEEC (“Airline Electronic Engineering Committee”).

The ICAO, which deploys the ATN network, imposes, through its recommendations, a common base of usage requirements. Among its recommendations, the ICAO specifies an application CM (“Context Management”) for initiating the digital data exchanges (Datalink exchanges) when an aircraft enters into contact with a ground air traffic control station. This CM application formalizes an exchange of information (version number, application types, ATN network address, etc.) enabling the aircraft and the control center to prepare the context in which they will exchange digital data, that is, in practice, to determine the common applications between the aircraft and the ground which are interoperable.

When the aircraft enters into a geographical area covered by the ATN network from an area that is not covered, the CM application, which enables identification with its ATN network correspondent, constitutes an obligatory transition prior to the use of another datalink application. The problem posed to the crew of an aircraft by a CM application is the need for prior knowledge of its ATN network address at the ground control center to be contacted.

In the first implementations of this CM application, the solutions adopted were to allow the crew of an aircraft the choice of entering either directly the ATN network address to be contacted or the name of the ground control center, a configuration file establishing the correlation between the name of the ground control center and the address in the ATN network of its CM application. These solutions have the drawback of monopolizing the attention of a member of the crew of the aircraft for a task that does not directly concern the piloting of the aircraft.

The applicant has already proposed, in in U.S. Pat. No. 6,714,783, to automate, for the router on board an aircraft, the selection of the address in the ATN network of the CM application to be contacted to initiate datalink exchanges with a control center starting from the address in the ATN network of the routing center contacted and taking into account the hierarchical structure of the addresses of the ATN network.

The applicant has also proposed, in U.S. Pat. No. 6,931,248, to automate the selection of a ground telecommunication station and the transmission subnetwork used by adding to the flight plan a list of ground telecommunication stations with coverage areas within range of the planned route with the transmission subnetworks supported by these ground stations, and by providing the flight management computer with a logic control function selecting a ground station address associated with a type of transmission subnetwork according to the position of the aircraft along its planned route.

### SUMMARY OF THE INVENTION

An object of the present invention is to simplify the initiation of the digital communications via the ATN network between an aircraft and a ground air traffic control center, taking into account information broadcast by certain ground telecommunication stations, and to make it automatic to relieve the crew of this task.

The present invention relates to a method of determining an address that an aircraft entering into a coverage area of an aeronautical telecommunication network must contact to implement an application for preparing the context for digital data exchanges with a ground air traffic control center, said aeronautical telecommunication network comprising ground telecommunication stations providing the air-ground links and the routing function, and periodically broadcasting information enabling them to be identified by the aircraft entering into their geographical coverage areas. This method comprises the steps of:
creating a file associating, with each ground telecommunication station broadcasting identification information, the context preparation application address of the ground air traffic control center that is geographically the closest,
monitoring the reception of identification information broadcast by a ground telecommunication station, and
adopting as address to be contacted, the address of the context preparation application associated, in the file, with the identity of the ground telecommunication station corresponding to the received identification information.

Advantageously, when a ground telecommunication station of the network is geographically the closest out of several ground air traffic control centers, the ground telecommunication station has associated with it in the file the different context preparation application addresses of the ground air traffic control centers to which it is closest, considered in their order of distance, the address of the context preparation application of the closest ground control center constituting a default choice that can be modified before being taken into account, by the crew of the aircraft.

Advantageously, the ground telecommunication stations periodically broadcasting general information are VDL ground stations.

The invention further relates to an aeronautical telecommunication network router on board an aircraft, comprising:
a database incorporating a file associating, with each ground telecommunication station broadcasting identification information, the context preparation application address of the ground air traffic control center that is geographically the closest,
means of detecting the entry of the aircraft into a coverage area of a ground telecommunication station broadcasting identification information, and
address determination means selecting, as address to be contacted, the address of the context preparation application associated, in the file, with the identity of the ground telecommunication station corresponding to the identification information received by the detection means.

Advantageously, when a ground telecommunication station is geographically the closest out of several ground air traffic control centers, the ground telecommunication station has associated with it, in the file, the different addresses of the context preparation applications of the ground air traffic control centers to which it is closest, considered in their order of distance. The terminal then comprises acknowledgement means that can be actuated by the crew of the aircraft presenting the list of the possibilities with the address of the context preparation application of the closest ground control center as default choice that can be modified.

### BRIEF DESCRIPTION OF THE DRAWINGS

Other characteristics and advantages of the invention will become apparent from the description that follows of an embodiment given as an example. This description will be given in light of the drawing in which:

FIG. 1 diagrammatically represents the aeronautical telecommunication network ATN, and

FIG. 2 diagrammatically represents an onboard router architecture according to the invention.

### DETAILED DESCRIPTION OF PREFERRED EMBODIMENTS

The aeronautical telecommunication network ATN aims to provide ground-onboard and onboard-ground digital links that are reliable and operate at high speed for information exchanges between aircraft on the ground or in flight and centers on the ground, whether these centers are assigned to an air control activity, the information exchanged with the air control authorities then being called ATC, or to an aircraft or flight operation activity, the information exchanged with the airline or airlines operating the aircraft which can be very diverse then being called non-ATC.

Like any digital link, the aeronautical telecommunication network ATN enables information exchanges or dialogs between two tasks or applications run by remote processors, normally one processor located on board an aircraft and one processor located on the ground.

The aeronautical telecommunication network ATN is designed to use the different media that can be envisioned for air-ground and ground-air links (HF, VHF, S mode radar, satellite UHF) and to use on the ground data transmission networks, dedicated or otherwise, switched or unswitched, wired or wireless, with or without satellite relay, in order to convey the transmitted information to its destination.

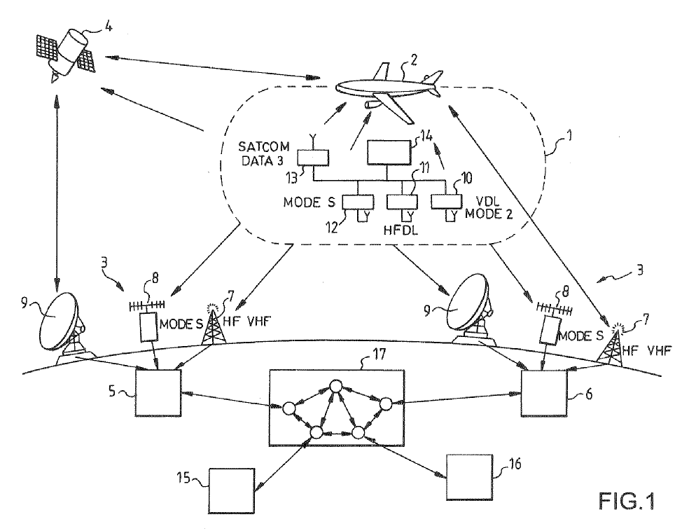

As represented in FIG. 1, the aeronautical telecommunication network ATN comprises an airborne part 1 on board each connected aircraft 2 and a terrestrial part 3.

The airborne part 1 consists of a variety of transceiver equipment on board an aircraft 2 and suited to the various media that can be used for the air-ground communications. Such transceiver equipment and its corresponding equipment on the ground constitute transmission subnetworks. FIG. 1 shows an aircraft 2 with an airborne part 1 of an aeronautical transmission network ATN comprising a number of transceivers, including a transceiver 10 constituting a VDL mode transmission subnetwork headend 2 operating in VHF mode according to a standardized specific protocol, a transceiver 11 constituting an HF DL mode transmission subnetwork headend operating in HF mode according to another standardized specific protocol, a transceiver 12 constituting an S mode transmission subnetwork headend operating in UHF mode in collaboration with a secondary radar according to another protocol, also standardized, and a transceiver 13 constituting a Satcom data 3 mode AMSS (“Aeronautical Mobile Satellite System”) communication subnetwork headend operating in UHF mode with a satellite relay 4, according to yet another standardized protocol. These various transceivers 10, 11, 12, 13 can have common parts, such that the different subnetworks may not all be available simultaneously. They can even not be fully present on an aircraft, this depending on the degree of equipment of the aircraft concerned. They are managed on board an aircraft by a logic controller 14, called a router, which, in addition to managing them, manipulates a memory stack through which the data to be exchanged with the ground passes to initiate, maintain and terminate a communication under the control of a software module called CMA (“Context Management Agent”), to maintain and terminate a subnetwork connection under the control of a software module called SN-SME (“Sub-Network System Management Entity”), to execute preloaded air control applications such as the periodic communication of the position of the aircraft to the ground control center under the control of a software module called “ATC Applis” and to execute preloaded fleet management applications such as tracking the consumption of the aircraft under the control of a software module called “Non-ATC Applis”.

The terrestrial part of the aeronautical telecommunication network ATN comprises ground telecommunication stations 5, 6 which are equipped, on the one hand, with air-ground and ground-air transmission means that can use HF-VHF transceivers 7, an S mode radar 8, a terrestrial satellite communication station 9, and enable them to communicate with the aircraft passing in their vicinity according to one or more of the communication modes provided: Satcom Data 3 subnetwork, VDL mode 2 subnetwork, S mode subnetwork or HF DL mode subnetwork, and, on the other hand, routing means linking them together and to various centers on the ground 15, 16 involved in the exchanges of information with the aircraft, including ground air traffic control centers, by digital data transmission networks 17, dedicated or otherwise, switched or unswitched, wired or wireless, with or without satellite relay.

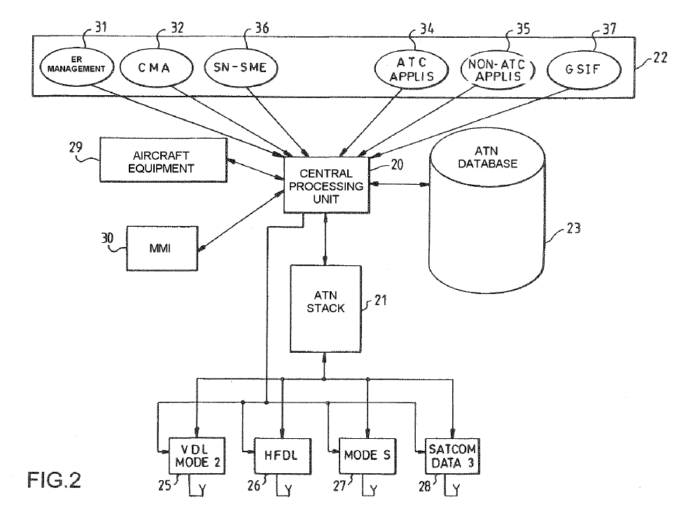

FIG. 2 diagrammatically illustrates an exemplary hardware and software architecture for an onboard router 14 of an aeronautical telecommunication network ATN.

This onboard router 14 comprises, as usual, a dedicated computer with a central processing unit 20, a memory and various input-output interfaces.

The memory comprises various parts, including mainly:
a part 21 called ATN stack with registers, the manipulation of which by the central processing unit 20 enables ATN network transmission protocols to be applied both to generate the data stream sent from onboard to the ground based on information to be transmitted and service information used to set up, maintain and terminate a link within the ATN network, and to extract information contained in the data stream received from the ground during a link and redirect it to the relevant onboard equipment,
a part 22 used to store various program modules, and
a part 23 used to store a database on the ATN network.

The input-output interfaces link the onboard router 14 with a variety of aircraft equipment, including, mainly:
the transceiver systems 25, 26, 27, 28 of the aircraft that can act as air-ground communication subnetwork headends for the ATN network,
equipment 29 of the aircraft that may need to use the ATN network to exchange information with the ground, and
at least one man-machine interface MMI 30 such as, for example, the MCDU (“Multipurpose Control Display Unit”), enabling a dialog between the onboard router and the crew of the aircraft, so that the crew can give its instructions to the router and obtain various information from it concerning the state of the links set up through the ATN network.

The program modules stored in the part 22 of the memory of the router and executed in timeshare mode by the central processing unit 20 of the router conventionally include:
a management and task allocation software module 31 managing the activities of the various onboard transceivers 25, 26, 27, 28 that can act as communication subnetwork headends,
a CMA software module 32 responsible for initiating, maintaining and disconnecting a link,
an “ATC Applis” software module 34 responsible for executing air control-related tasks,
a “non-ATC Applis” software module 35 responsible for executing tasks concerned with flight and aircraft management, and
an SM-SME software module 36 responsible for maintaining and terminating a subnetwork connection.

These various software modules will not be detailed because they are not part of the invention. They are designed by software engineering specialists taking into account both the specific features of the equipment on board the aircraft, the standardized protocols of the ATN network and the requirements of the air traffic control authorities and the airline operating the aircraft.

An air-ground information exchange is initiated by an aircraft. When an aircraft needs to communicate with the ground, the onboard CMA application sends, via one of the communication subnetworks available to the aircraft, an access connection request to the terrestrial ATN network called “CM-Logon.request” (CM standing for “Context Management”) and the receiving control center on the ground replies, when it receives this “CM-Logon.request” access connection request, with an access connection proposal called “CM-Logon.response”.

To operate, the CMA software module needs to know the address of the recipient ground application in the ATN network. To determine this address and enable an automatic handshake procedure to be undertaken, it is proposed to use the general data broadcast by certain ground telecommunication stations, including VDL ground stations.

The VDL ground stations periodically broadcast all the information needed for the aircraft to communicate in the form of frames using the GSIF protocol. The information contained in the GSIF frames includes the various protocols and radio frequencies that the sending ground station supports, and the operational parameters proposed by the service provider responsible for managing the radio channel. These parameters describe the necessary characteristics that must be used on the onboard router in the aircraft to be able to set up an effective datalink with the ground station.

This GSIF general data sent periodically from the ground does not make it possible to directly obtain the network address of a recipient application but does enable the ground telecommunication station concerned to be identified. From the identification of the ground telecommunication station, it is possible to locate it geographically and determine the address of the context preparation CM application of the ground air traffic control center that is geographically the closest, by looking up a file giving the addresses of the CM applications of the ground control centers by geographical areas.

To do this, the router 14 on board an aircraft is provided, as shown in FIG. 2, with a GSIF software module 36 that uses the general data broadcast by the routing centers on the ground. Also, its ATN database 23 is provided with a file linking each ground telecommunication station broadcasting general identification data with the address or addresses of context preparation CM application of the ground air traffic control center or centers that are the closest.

When there is only one CM application address corresponding to the identification of the ground telecommunication station, which is the commonest situation, the router on board an aircraft can totally automatically proceed with the exchange and with the identification of the application configuration, at the datalink level, of the aircraft and of the control center on the ground. When there is a possible choice of CM application addresses, this choice, always very limited, is left to the crew of the aircraft whose datalink management task is considerably simplified. Furthermore, when a choice is offered to the crew of the aircraft, it can be made optional by presenting the address of the CM application of the ground air traffic control center that is closest to the identified ground routing center as a default choice that can be modified.

1. A method of determining an address that an aircraft entering into a coverage area of an aeronautical telecommunication network must contact to implement an application for preparing a context for digital data exchanges with an ground air traffic control center, the aeronautical telecommunication network comprising ground telecommunication stations providing air-ground links and a routing function, and periodically broadcasting general information enabling the ground telecommunications stations to be identified by the aircraft entering into geographical coverage areas of the ground telecommunications stations said method of determining an address comprising the step of:
creating a file associated, with each ground telecommunication station broadcasting identification information with the context preparation application address of the ground air traffic control center that is geographically the closest,
monitoring reception of identification information broadcast by a ground telecommunication station, and
adopting an address to be contacted, the address of the context preparation application associated, in the file, with the identity of the ground telecommunication station corresponding to the received identification information.

2. The method as claimed in claim 1, wherein, a ground telecommunication station broadcasting general information, that is geographically the closest out of several ground air traffic control centers, is associated in the file with the different context preparation application addresses of the ground air traffic control centers to which it is closest, considered in their order of distance, the address of the context preparation application of the closest ground control center constituting a default choice that can be modified by the crew of the aircraft.

3. The method as claimed in claim 1, wherein the ground telecommunication stations periodically broadcasting general information are VDL ground stations.

4. An aeronautical telecommunication network router on board an aircraft, comprising:
a database incorporating a file associating, with each ground telecommunication station broadcasting identification information, and context preparation application address of the ground air traffic control center that is geographically the closest,
means of detecting the entry of the aircraft into a coverage area of a ground telecommunication station of the network broadcasting identification information, and
address determination means selecting, as address to be contacted, the address of the context preparation application associated, in the file, with the identity of the ground telecommunication station corresponding to the identification information received by the detection means.

5. The router as claimed in claim 4 wherein, a ground telecommunication station of the network is geographically close to several ground air traffic control centers, is associated in the file with the different addresses of the context preparation applications of the ground air traffic control centers to which it is close, considered in their order of distance.

6. The router as claimed in claim 5, further comprising acknowledgement means that can be actuated by the crew of the aircraft, presenting, in cases where there are several possibilities, the list of the possible context preparation application addresses with the address of the context preparation application of the ground control center closest to the identified ground telecommunication station as a default choice that can be modified.
